(19) United States
(12) Patent Application Publication
(10) Pub. No.: US 2005/0202202 A1
(43) Pub. Date: Sep. 15, 2005

(54) Production method for disk-like recording medium

(76) Inventors: Kenji Yoneyama, Chuo-ku,Tokyo (JP); Kazushi Tanaka, Chuo-ku,Tokyo (JP); Naoki Hayashida, Tokyo (JP); Mamoru Usami, Tokyo (JP)

Correspondence Address: DARBY & DARBY P.C., P. O. BOX 5257, NEW YORK, NY, 10150-5257, US

(21) Appl. No.: 10/528,243

(22) PCT Filed: Sep. 17, 2003
(86) PCT No.: PCT/JP03/11816

§ 371 Date: Mar. 17, 2005

(30) Foreign Application Priority Data
Sep. 19, 2002 (JP) 2002-274123

(51) Int. Cl. B32B 3/02

(52) U.S. Cl. 428/64.4

(57) ABSTRACT

A disc-shaped recording medium manufacturing method involves the use of electron beams for easily curing a resin layer composed of a resin material that is hard to be cured by irradiation of ultraviolet rays and capable of manufacturing a disc-shaped recording medium with a high yield without affecting a recording layer even by irradiating the electron beams. The disc-shaped recording medium manufacturing method of manufacturing the disc-shaped recording medium having a layer composed mainly of resin on a recording layer provided on a disc-shaped substrate, includes the steps of irradiating the layer composed mainly of the resin with electron beams of which an acceleration voltage is equal to or higher than 20 kV and is equal to or lower than 100 kV, and curing at least the surface of the layer composed mainly of the resin.

### TECHNICAL FIELD

The present invention relates to a method of manufacturing a disc-shaped recording medium such as an optical disc, etc.

### BACKGROUND ARTS

Optical discs such as a CD (Compact Disc), a DVD (Digital versatile Disc), etc. have hitherto been utilized as optical information recording mediums. Over the recent years, however, there has been a progress of developing a blue semiconductor laser of which an oscillation wavelength is on the order of 400 nm. The development of a next generation high-density optical disc such as a high-density DVD, etc. capable of recording with a higher density than the general DVD, is conducted by use of this type of blue semiconductor laser.

Considered as one example of a now-thinkable layer structure of this type of next generation high-density optical disc is a high-density optical disc of such a type that a recording layer for recording information, a light transmitting layer that transmits laser beams for recording and reproducing so that the laser beams get incident on the recording layer and a lubricating layer taking contact with a member on the side of an optical pickup into consideration, are stacked on a substrate composed of a resin material such as polycarbonate, etc.

The light transmitting layer and the lubricating layer are, when formed, irradiated with ultraviolet rays after being coated for curing. When especially the lubricating layer, etc. is formed of a material such as silicon compound, fluorine compound, etc. that exhibit radial polymerization double-bond to a thickness of several tens of nm, however, it is difficult to cure the lubricating layer by the irradiation of the ultraviolet rays due to an inhibition of radical reaction as caused by an existence of oxygen. Further, there might be a case in which a characteristic as the lubricating layer deteriorates if a reaction initiator is added thereto. In such a case, if the reaction initiator is not added, the curing is still hard to be done by the irradiation of the ultraviolet rays, and the lubricating layer having a sufficient quality can not be formed with high adhesion to a light transmitting layer existing thereunder. (Refer to Japanese Patent Laid-Open Application Publication No.4-019839, and Japanese Patent Laid-Open Application Publication No.11-162015)

### DISCLOSURE OF THE INVENTION

The present invention makes, in view of the above problems inherent in the prior arts, a proposal of employing electron beams for easily curing part of a surface layer and/or a resin layer such as a light transmitting layer, etc. existing thereunder, composed of materials that are hard to be cured by irradiation of ultraviolet rays, however, in this case, when energy of the electron beams rises, it is considered that adverse influence is exerted on a recording layer existing under the resin layer, and therefore the present invention aims at providing a disc-shaped recording medium manufacturing method capable of easily curing the surface layer composed of a material that is hard to be cured by the ultraviolet rays and of manufacturing the disc-shaped recording medium with a high yield without affecting the recording layer even by the irradiation of the electron beams.

To accomplish the above object, according to the present invention, a method of manufacturing a disc-shaped recording medium having a layer composed mainly of resin on a recording layer provided on a disc-shaped substrate, is characterized in that the layer composed mainly of the resin is irradiated with electron beams of which an acceleration voltage is equal to or higher than 20 kV and is equal to or lower than 100 kV, thereby curing at least the surface of the layer composed mainly of the resin.

According to the disc-shaped recording medium manufacturing method, the layer composed mainly of the resin is irradiated with the electron beams having larger energy than the ultraviolet rays have, and hence it is possible to easily cure the layer composed mainly of the rains that is hard to be cured by the irradiation of the ultraviolet rays. Besides, the acceleration voltage of the electron beams is equal to or lower than 100 kV, and therefore adverse influence is not exerted on the recording layer existing under the layer composed mainly of the resin serving as a curing object. Accordingly, it is possible to highly efficiently cure the layer (which will hereinafter simply referred to as a [resin layer] as the case may be) composed mainly of the resin that is hard to be cured by the irradiation of the ultraviolet rays, thereby improving productivity and enabling the disc-shaped recording medium with a high yield because of exerting no adverse influence upon the recording layer.

Note that the light transmitting layer involves using the resin as a main component and corresponds to the resin layer according to the present invention. Further, a lubricating layer is a layer of one mode included in a definition of the surface layer according to the present invention.

Moreover, the surface layer formed on the layer composed mainly of the resin can be also cured. Namely, when the layer composed mainly of the resin is formed in an as-uncured state under the surface layer, part of the layer composed mainly of the resin can be simultaneously cured by the irradiation of the electron beams, and consequently adhesion between the two layers is improved.

Note that the surface layer may be formed of a material, e.g., a lubricating layer forming material and a material exhibiting water repellency and oil repellency, which are different from the layer composed mainly of the resin. Moreover, such a layer may also be either single-layered or multi-layered. Furthermore, the layer composed mainly of the resin may be formed of a plurality of layers, wherein, for example, a hard coat layer may be provided on the side of the surface of the layer composed mainly of the resin, and these layers are stacked to form the layer composed mainly of the resin.

Further, it is preferable that the surface layer is a lubricating layer. The lubricating layer, even when formed of the material that is hard to be cured by the irradiation of the ultraviolet rays, can be easily cured by the irradiation of the electron beams.

Moreover, the layer composed mainly of the resin and the surface layer can be uniformly and efficiently irradiated with the electron beams by irradiating the disc-shaped substrate with the electron beams while rotating the disc-shaped substrate.

Moreover, it is preferable that an electron beam shield container rotatably accommodates the disc-shaped substrate, and an interior of the shield container is replaced with an inert gas atmosphere by introducing an inert gas into the interior of the shield container. Further, the inert gas may be introduced into the interior of the shield container after depressurizing the interior thereof. With this contrivance, the interior of the container can be easily efficiently replaced with the inert gas atmosphere.

Moreover, it is preferable that the inert gas is introduced while measuring an oxygen concentration within the shield container. It is also preferable that the inert gas is flowed through the vicinity of an irradiation window of an electron beam irradiation unit for irradiating the electron beams toward a gas discharge port from a gas introduction port, thereby cooling off the vicinity of the irradiation window. Note that a cooling temperature be, it is preferable, controlled by adjusting a flow rate of the inert gas on the basis of a temperature measured by a temperature sensor provided in the vicinity of the irradiation window.

Moreover, it is preferable that the acceleration voltage is set in consideration of a thickness of the layer composed mainly of the resin. The acceleration voltage, by which the electron beams do not reach the recording layer without exerting any adverse influence, is selected and then set. Incidentally, it is preferable that a distance between the irradiation window of the electron beam irradiation unit that emits the electron beams and the surface of the resin layer is 10 mm through 30 mm.

### BRIEF DESCRIPTION OF THE DRAWINGS

FIG. 1 is a side sectional view schematically showing an electron beam irradiation apparatus usable for a disc-shaped recording medium manufacturing method according to the present embodiment; and

FIG. 2 is a side sectional view schematically showing an optical recording disc manufactured in the present example.

### BEST MODE FOR CARRYING OUT THE INVENTION

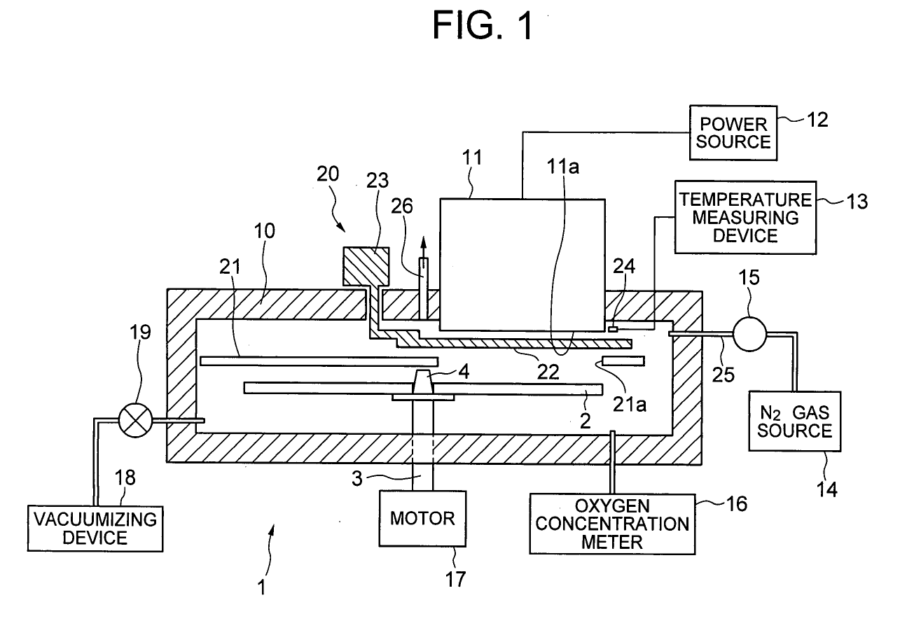

An electron beam irradiation apparatus usable for a method of manufacturing a disc-shaped recording medium according to an embodiment of the present invention, will hereinafter be described with reference to FIG. 1. FIG. 1 is a side view schematically showing such an electron beam irradiation apparatus.

As illustrated in FIG. 1, an electron beam irradiation apparatus 1 includes a shield container 10 that rotatably accommodates a disc-shaped recording medium 2 and is composed of stainless steel in order to shield the electron beams, a motor 17 for rotationally driving the disc-shaped recording medium 2 held by engaging a central hole of the disc-shaped recording medium 2 with an engaging member 4 through a rotary shaft 3, an electron beam irradiation unit 11 for irradiating the disc-shaped recording medium 2 with the electron beams under a low-acceleration voltage in a radial direction from an irradiation surface 11a, a power source 12 for applying a voltage to the electron beam irradiation unit 11, a temperature sensor 24 disposed in the vicinity of the irradiation surface 11a, and a temperature measuring device 13 that is connected to the temperature sensor 24 and measures an ambient temperature to the irradiation surface 11a.

The electron beam irradiation apparatus 1 further includes an oxygen concentration meter 16 for measuring an oxygen concentration of oxygen in an airtight closed space within the shield container 10, a nitrogen gas source 14 that supplies a nitrogen gas for replacing the interior of the shield container 10 with a nitrogen gas atmosphere, and a gas flow rate control valve 15 capable of controlling a gas flow rate when the nitrogen gas flows so that the nitrogen gas is introduced via a gas introduction port 25, passes through in the vicinity of the irradiation surface 11a and is discharged from a gas discharge port 26. Further, there might be a case of providing a vacuumizing device 18 for evacuating and thus depressurizing the interior of the shield container 10 via a valve 19.

The electron beam irradiation apparatus 1 further includes an aperture-formed disc 21 having a larger diameter than that of the disc-shaped recording medium 2 and disposed between the disc-shaped recording medium 2 and the irradiation surface 11a of the electron beam irradiation unit 11, and a shutter driving mechanism 20 having a shutter member 22 disposed between the disc 21 and the irradiation surface 11a, and a slider 23 for driving the shutter member 22.

Further, the shutter member is driven by the slider 23, thereby opening and closing an aperture 21a of the disc 21. The shutter member 22, when in a closing position, blocks the electron beams emitted from the electron beam irradiation unit 11 and, when in an opening position, permits the electron beam to pass through, whereby a radial area on the disc-shaped recording medium 2 is irradiated with the electron beams.

Further, the electron beam irradiation unit 11 includes a cylindrical electron beam irradiation tube. A voltage is applied to the electron beam irradiation tube from the power source 12, and the radial area on the disc-shaped recording medium 2 is irradiated with the electron beams of which an acceleration voltage is equal to or larger than 20 kV and is equal to smaller than 100 kV from the irradiation surface 11a.

An operation of the thus constructed electron beam irradiation apparatus 1 in FIG. 1 will be explained. To begin with, the disc-shaped recording medium 2, of which a surface is formed with a layer composed of uncured resin as a main component, is held by engaging the central hole of the disc-shaped recording medium 2 with the engaging member 4, and the shield container 10 is air-tightly closed. Next, the vacuumizing device 18, if provided according to the necessity, operates to depressurize the interior of the shield container 10, and thereafter the nitrogen gas is introduced into the interior of the shield container 10 via the gas flow rate control valve 15 from the nitrogen gas source 14, whereby the interior of the shield container 10 can be easily replaced with a nitrogen atmosphere.

Then, the oxygen concentration meter 16 detects a decrease down to a predetermined oxygen concentration in the interior of the shield container 10, and the disc-shaped recording medium 2 is rotated at a predetermined rotating speed by driving the motor 17. On the other hand, the voltage is applied to the electron beam irradiation unit 11 from the power source 12, thereby generating the electron beams. Next, the shutter member 22 located in the closing position is moved to the opening position by operating the shutter driving mechanism 20 to drive the slider 23, thereby irradiating the surface of the radial area on the on-rotating disc-shaped recording medium 2 with the electron beams.

The on-rotating disc-shaped recording medium 2 is irradiated with the electron beams in the radial direction, and hence the entire irradiated surface of the disc-shaped recording medium 2 can be irradiated with the electron beams. Then, after irradiating the disc-shaped recording medium 2 with the electron beams for only a predetermined period of time, similarly the shutter member 22 is moved to the closing position by operating the shutter driving mechanism 20, thereby finishing irradiating the disc-shaped recording medium 2 with the electron beams.

Further, during the emission of the electron beams from the electron beam irradiation unit 11, the nitrogen gas from the nitrogen gas source 14 flows through the vicinity of the irradiation surface 11a via the gas introduction portion 25 and further flows into the gas discharge portion 26, thereby making it possible to cool off the irradiation surface 11a that rises in its temperature when emitting the electron beams and likewise cool off the shutter member 22. Moreover, a temperature ambient to the irradiation surface 11a is measured by the temperature sensor 24 and by the temperature measuring device 13, and a flow rate of the nitrogen gas is controlled based on this measured temperature by the gas flow rate control valve 15. The temperature ambient to the irradiation surface 11a can be controlled to be equal to or lower than a fixed temperature.

As described above, the electron beam irradiation apparatus in FIG. 1 irradiates the surface of the on-rotating disc-shaped recording medium 2 with the electron beams, thereby enabling the surface of the disc-shaped recording medium 2 to be highly efficiently irradiated with the electron beams exhibiting greater energy than the ultraviolet rays have. It is therefore feasible to facilitate curing of even the layer mainly composed of the resin that is hard to be cured by the irradiation of the ultraviolet rays.

Further, because of being irradiated with the electron beams of which the acceleration voltage is equal to or smaller than 100 kV, whereby the electron beam energy is highly efficiently applied to the layer composed mainly of the resin within a thin range from the surface of the disc-shaped recording medium 2, and the electron beams do not affect a recording layer existing thereunder, thereby improving a yield of the disc-shaped recording medium. Moreover, when the acceleration voltage is less than 20 kV, the electron beam becomes hard to reach the surface of the disc-shaped medium.

For example, the electron beam irradiation tubes, configuring the electron beam irradiation unit 11 of the electron beam irradiation apparatus 1, for irradiating the electron beams having the low acceleration voltage, are available on the market as offered by Ushio Electric Co., Ltd. For instance, the resin layer can be instantaneously efficiently cured under the condition that the acceleration voltage is 50 kV, and a tube current is on the order of 0.6 mA/piece.

Note that a window material for forming the irradiation window of the electron beam irradiation tube is preferably a silicon thin film having a thickness of approximately 3 μm, thereby making it possible to extract the electron beams accelerated at the acceleration voltage that is equal to or smaller than 100 kV, which can not be extracted by the conventional irradiation window. Further, the “radial direction” described above connotes a direction extending toward the outer periphery of the disc-shaped medium from a point eccentric from the center of rotation of the disc-shaped medium.

### EXAMPLE

Next, the present invention will be described in greater detail by way of an example but is not limited to this example.

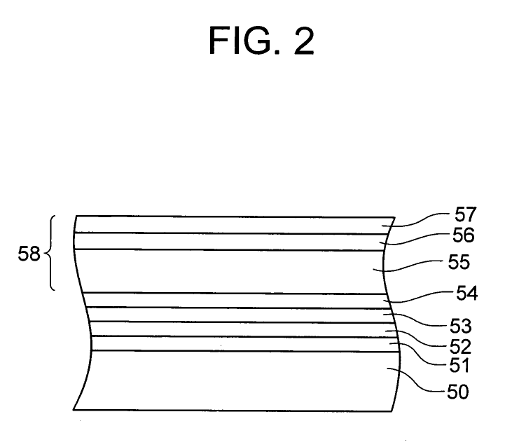

A sample of an optical recording disc having the layer structure as shown in FIG. 2 is manufactured as the disc-shaped recording medium in the following procedure. To be specific, a reflection layer 51 composed of Al₉₈Pd₁Cu₁ (atomic ratio) is formed by a sputtering method on the surface of a disc-shaped support substrate 50 (that is made of polycarbonate, 120 mm in diameter and 1.1 mm in thickness) formed with grooves for recording information. A recording track pitch based on a groove recording system is set to 0.32 μm.

Subsequently, a second dielectric layer 52 having a thickness of 20 nm is formed on the surface of the reflection layer 51 on the basis of the sputtering method by use of a target composed of Al₂O₃.

Next, a recording layer 53 having a thickness of 12 nm is formed on the surface of the second dielectric layer 52 on the basis of the sputtering method by using an alloy target composed of a phase-change material. A composition (atomic ratio) of this recording layer 53 is Sb₇₄Te₁₈ (Ge₇In₁). Subsequently, a first dielectric layer 54 having a thickness of 130 nm is formed on the surface of this recording layer 53 on the basis of the sputtering method by use of a target composed of ZnS (80 mole %)-SiO₂ (20 mole %). The above layers 51, 52, 53 and 54 will hereinafter be generically termed a recording layer.

Next, an ultraviolet ray curing type resin having the following composition is coated over the surface of the first dielectric layer 54 by a spin coat method and is irradiated with the ultraviolet rays, thereby forming a light transmitting layer having a thickness of 97 μm.

Urethane acrylate oligomer (made by Mitsubishi Rayon Co., Ltd., Diabeam UK6035) . . . 50 parts by weight

Isocyanuric acid EO-denatured tri-acrylate (made by Toagosei Co., Ltd., Aronics M315) . . . 10 parts by weight

Isocyanuric acid EO-denatured di-acrylate (made by Toagosei Co., Ltd., Aronics M215) . . . 5 parts by weight

Tetrahydrofurfurryl acrylate . . . 25 parts by weight

Photo-polymerization initiator (1-hydroxy cyclohexyl phenyl ketone) . . . 3 parts by weight

Further, after coating an ultraviolet-ray/electron beam curing type hard coat agent (made by JSR Corp., Desolight Z7503) over the light transmitting layer 55 by the spin coat method, a dilution solvent within the coating is removed by heating at 60° C. in the atmospheric air, thereby forming an uncured hard coat layer 56 having a thickness of 3 μm. Subsequently, a solution of Furorynate FC-77 (made by Sumitomo 3M Co., Ltd.) containing 0.5% (mass percentage) perfluoropolyether di-acrylate (an acryl-denatured product having a molar weight of approximately 2000, Fombin ZDOL made by Aujimont Corp.), is coated over the uncured hard coat by the spin coat method in a way that aims at a thickness of several tens of nm, and is dried for 3 min. at 50° C., thereby forming an uncured surface layer 57.

Thereafter, a disc-shaped substrate formed with the uncured surface layer 57 as illustrated in FIG. 2 is irradiated with the electron beams under a flow of nitrogen with an oxygen concentration of 200 ppm or less and with an irradiation dose of 10 Mrad in a way that changes the acceleration voltage of the electron beams within a range of 50 kV through 100 kV as shown in the following Table 1 while rotating, as shown in FIG. 1, this disc-shaped substrate, thereby curing the hard coat layer 56 and the surface layer 57 simultaneously. Samples of the optical recording disc are thus acquired.

When observing an external configuration of each of the thus-acquired samples of the optical recording disc, some samples, of which recording layers are observed partly floating (raised) depending on a magnitude of the acceleration voltage of the electron beams emitted, are found out. Table 1 shows the result.

TABLE 1

| | Acceleration Voltage (kV) | | | | |
|---|---|---|---|---|---|
| | 50 | 100 | 120 | 150 | 200 |
| Recording | 0 | 0 | 4 | 5 | 5 |
| Layer | | | | | |
| Damaged | | | | | |
| (*) | | | | | |

(*) The number of recording layers with damage observed.

As shown in Table 1, the recording layer has no damage up to the acceleration voltage of 100 kV. In contrast, however, the damage to the recording layer is observed from some samples at 120 kV, and is observed from all the samples at 150 kV or higher. This is considered such that the electron beams neither penetrate the resin layer 58 (formed on the recording layer by stacking the layers 55, 56, 57) having a thickness of approximately 100 μm nor reach the recording layer till the acceleration voltage comes to 100 kV, but reach the recording layer when the acceleration voltage exceeds 100 kV, resulting in the damage to the recording layer.

The present invention has been described by way of the embodiment and the example but is not limited to the embodiment discussed above and the example given above, and can be modified in a variety of forms within the scope of the technical concept of the present invention. For example, the disc-shaped recording medium that can be manufactured by the manufacturing method according to the present embodiment may be, as a matter of course, an optical information recording medium such as a variety of optical discs, etc. It is therefore preferable that a proper acceleration voltage equal to or lower than 100 kV is set in consideration of the thickness from the outermost surface down to the recording layer, depending on the type of the optical information recording medium.

Moreover, the gas replacing the atmosphere in the container of the electron beam irradiation apparatus 1 is not limited to the nitrogen gas, and may be an inert gas such as argon gas, helium gas, Co₂, etc. and may also be a mixture gas of these two or more gases.

### INDUSTRIAL APPLICABILITY

According to the disc-shaped recording medium manufacturing method of the present invention, it is possible to easily cure at least part of the surface layer and/or the resin layer existing thereunder, composed of the materials that are hard to be cured by the irradiation of the ultraviolet rays, and to manufacture the disc-shaped recording medium with a high yield without affecting the recording layer even by the irradiation of the electron beams.

1. A method of manufacturing a disc-shaped recording medium having a layer composed mainly of resin on a recording layer provided on a disc-shaped substrate, comprising the steps of irradiating:
the layer composed mainly of the resin is irradiated with electron beams of which an acceleration voltage is equal to or higher than 20 kV and is equal to or lower than 100 kV, thereby curing at least the surface of the layer composed mainly of the resin.

2. A method of manufacturing a disc-shaped recording medium according to claim 1, further comprising the steps of curing a surface layer formed on the layer composed mainly of the resin.

3. A method of manufacturing a disc-shaped recording medium according to claim 2, wherein the surface layer is a lubricating layer.

4. A method of manufacturing a disc-shaped recording medium according to claim 1, further comprising the steps of irradiating said disc-shaped substrate with the electron beams while rotating said disc-shaped substrate.

5. A method of manufacturing a disc-shaped recording medium according to claim 1, wherein an electron beam shield container rotatably accommodates said disc-shaped substrate, and further comprising the steps of replacing
an interior of said shield container is replaced with an inert gas atmosphere by introducing an inert gas into the interior of said shield container.

6. A method of manufacturing a disc-shaped recording medium according to claim 5, wherein the inert gas is introduced while measuring an oxygen concentration within said shield container.

7. A method of manufacturing a disc-shaped recording medium according to claim 5 further comprising the steps of flowing the inert gas through the vicinity of an irradiation window of an electron beam irradiation unit for irradiating the electron beams toward a gas discharge port from a gas introduction port, thereby cooling off the vicinity of said irradiation window.

8. A method of manufacturing a disc-shaped recording medium according to claim 1 further comprising the steps of setting the acceleration voltage in consideration of a thickness of the layer composed mainly of the resin.
